(19) United States
(12) Patent Application Publication
(10) Pub. No.: US 2008/0201074 A1
(43) Pub. Date: Aug. 21, 2008

(54) SYSTEM AND METHOD FOR CREATING AND SHARING NAVIGATION ROUTES WITH ELECTRONIC DEVICES

(75) Inventors: Matthew F. Bleckman, Lenexa, KS (US); Christopher B. Bilderback, Olathe, KS (US); Mark D. Tompkins, Overland Park, KS (US); Scott J. Brunk, Edgerton, KS (US); Travis W. Bennett, Gardner, KS (US); Scott T. Moore, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town (KY)

(21) Appl. No.: 11/675,547

(22) Filed: Feb. 15, 2007

(51) Int. Cl. G01C 21/34; G01C 21/00

(52) U.S. Cl. 701/211; 701/213

(57) ABSTRACT

A device which converts geographic coordinates such as track logs to navigational routes matched to known road networks includes a GPS receiver; a display; and a processing system. The GPS receiver determines a series of geographic coordinates corresponding to points along a path traveled by a user of the device. The processing system accesses the series of geographic coordinates; compares them to a database of known paths to find a match; and displays at least a portion of the matching path along with navigational information which permits the user to generally follow the series of geographic coordinates while traveling on the path.

### BACKGROUND

1. Field

The present invention relates to electronic devices such as navigation devices, and the like. More particularly, the invention relates to a device, system, and method for converting geographic coordinates such as track logs to navigational routes matched to known paths such as known road networks.

2. Description of the Related Art

Users of navigational devices frequently like to store the coordinates of points along a path which they have traveled. These collection of points, commonly referred to as a track log, are the electronic equivalent of laying down a bread crumb trail to mark a path. These points can then be shown strung together on a map page to form a track so the user can see where he or she has been.

Many navigational devices also provide guidance to assist a user in reverse-navigating a track to return to its starting point or to allow the user to navigate a stored track at a later time. These devices often remove some points from a multi-point track log so that the track is simplified into one that has a lesser number of points which may traversed by following a series of straight-line “legs.” These legs may be displayed by the device to help guide the user along the track.

Although such track log features are very popular, they do not always provide enough navigational assistance to users. For example, existing navigational devices only provide point-to-point navigation, wherein the device guides the user toward the next point in the track log. The devices make no attempt to instruct a user how to actually follow the straight-line legs of the track displayed, but instead merely provide a rough direction and distance of travel. Consequently, a person viewing a track must determine the best road, trail, or other path to take while attempting to follow the track. This task is especially difficult while driving a vehicle because navigation decisions must be made quickly while traveling at higher speeds.

### SUMMARY

Accordingly, the present invention is directed to a device, system, and method for converting a series of geographic coordinates such as a track log to a navigational route matched to known paths such as known road networks. In exemplary embodiments, the present invention may be implemented within an electronic device such as a portable electronic device, a vehicle-installed navigation system, or the like. One embodiment of the electronic device includes a location-determining component such as a GPS receiver; a display; and a processing system coupled with the GPS receiver and the display. The GPS receiver receives satellite signals from a plurality of GPS satellites and determines location information as a function of the satellite signals. For example, the GPS receiver may determine a track log or other series of geographic coordinates corresponding to points along a path traveled by a user of the device. The processing system is configured to convert the series of geographic coordinates into a navigational route which can be easily followed by the user. Specifically, the processing system accesses the series of geographic coordinates created by the GPS receiver; compares the series of geographic coordinates to a database of known paths to find a match; and displays at least a portion of the matching path along with navigational information which permits the user to generally follow the series of geographic coordinates while traveling on the path. The database of known paths searched by the processing system may include the geographic coordinates of known road segments, hiking trails, tracks, or any other paths which are frequently mapped.

The present invention may be used, for example, when a user travels over a scenic set of roads, hiking trails, or any other path and saves a series of geographic coordinates as a track log for the path. If the user wants to re-trace the path at a later date, the processing system accesses the track log, compares it to a database of known paths, and then displays the track log over the known path which most closely matches the track log. The processing system may also display navigational information such as turn-by-turn instructions to assist the user in following the track log on the known path.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWING FIGURES

Embodiments of the present invention are described in detail below with reference to the attached drawing figures, wherein:

FIG. 1 is an isometric view illustrating an electronic device in accordance with an exemplary embodiment of the present invention;

FIG. 2 is a block diagram illustrating certain components of the device of FIG. 1;

FIG. 3 is schematic diagram of a Global Positioning System (GPS) that may be utilized by various embodiments of the present invention;

FIG. 4 is a flow diagram illustrating selected steps in a method of the present invention;

FIG. 5 is a flow diagram illustrating selected steps in a method of the present invention;

FIG. 5A is a continuation of FIG. 5;

FIG. 6 is a sample screen display of the electronic device illustrating a track log; and

FIG. 7 is another sample screen display of the electronic device illustrating a track log which has been converted to a navigational route matched to a known road network.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense.

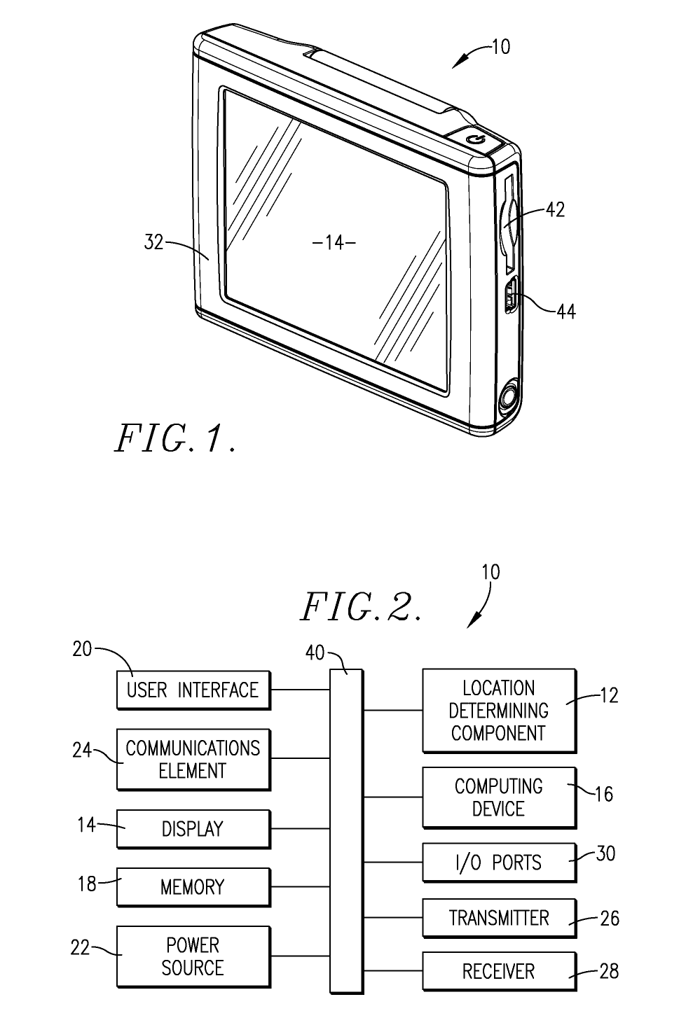

The present invention can be implemented in hardware, software, firmware, or a combination thereof. In one embodiment, however, the invention is implemented with an electronic device 10, an example of which is illustrated in FIG. 1. The electronic device 10 may be a portable navigation device, personal travel assistant, GPS-enabled mobile telephone, GPS-enabled personal digital assistant (PDA), GPS-enabled radio, or the like. Alternatively, the electronic device 10 may comprise a navigation system installed in a vehicle such as an automobile, truck, motorcycle, or the like. In one embodiment, the electronic device 10 includes a location determining component or system 12 such as a GPS receiver; a display 14; and a processing system or like computing device 16 coupled with the GPS receiver and the display.

As explained in more detail below, the location determining component 12 may determine a track log or other series of geographic coordinates corresponding to points along a path traveled by a user of the device. The processing system 16 converts the series of geographic coordinates into a navigational route which can be easily followed by a user. Specifically, the processing system 16 accesses the series of geographic coordinates generated by the location determining component and compares the series of geographic coordinates to a database of known paths such as known road segments to find a match. The processing system 16 may then cause the display 14 to display at least a portion of the matching path along with navigational information which permits the user to generally follow the series of geographic coordinates while traveling on the known path. Preferably, the resulting path generally preserves the position and shape of the original track log, but is matched to a road network where possible. Additionally or alternatively, the processing system 16 may cause at least a portion of the matching path and optionally the navigational information to be stored in a memory such as an internal memory a removable memory (either directly or after display to the user). Once obtained, at least a portion of the matching path may further be shared with other electronic devices. For example, a matching path, or portion thereof, may be stored on a removable memory and transferred from the electronic device 10 to a second electronic device. Alternatively, the matching path, or portion thereof, may be transmitted between the electronic device 10 and a second electronic device via a wired or wireless connection. Other information (e.g., Points of Interest (POI), audio and video files, etc.) may be shared between two or more electronic devices in the same or a similar manner.

In embodiments of the invention, the electronic device 10 may be any device operable to receive, utilize, or otherwise determine geographic information such as a current location of the device. Thus, the device 10 may include computers, televisions, radios, portable processing systems such as laptops or personal data assistants (PDAs), cellular telephones, and portable entertainment devices. In exemplary embodiments, the electronic device 10 is a portable navigation device such as a GPS navigation device, a GPS-enabled cell phone, or a GPS-enabled PDA. Examples of such navigation devices and personal travel assistant devices are manufactured by GARMIN INTERNATIONAL, INC. of Olathe, Kans. The electronic device 10 and its components illustrated and described herein are merely examples of a device and components that may be used to implement the present invention and may be replaced with other devices and components without departing from the scope of the present invention.

In addition to the location determining component 12, display 14, and processing system 16 discussed above, an embodiment of the electronic device 10 may also include a memory 18, a user interface 20, a power source 22, a communications element 24, a transmitter 26, a receiver 28, one or more I/O ports 30, and a housing 32 for housing the various components of the device 10 as best illustrated in FIGS. 1 and 2.

The location determining component 12 may be a global positioning system (GPS) receiver, such as, in particular, a parallel channel GPS receiver, or the like, which provides geographic location information for the device 10. In general, the GPS is a satellite-based radio navigation system capable of determining continuous position, velocity, time, and direction information for an unlimited number of users. Formally known as NAVSTAR (Navigation Signal Timing and Ranging), the GPS incorporates a plurality of satellites which orbit the earth in extremely precise orbits. Based on these precise orbits, GPS satellites can relay their location to any number or receiving units.

The GPS system is implemented when a device specially equipped to receive GPS data begins scanning radio frequencies for GPS satellite signals. Upon receiving a radio signal from a GPS satellite, the device can determine the precise location of that satellite via one of different conventional methods. The device will continue scanning for signals until it has acquired at least three different satellite signals. Implementing geometrical triangulation, the receiver utilizes the three known positions to determine its own two-dimensional position relative to the satellites. Acquiring a fourth satellite signal will allow the receiving device to calculate its three-dimensional position by the same geometrical calculation. The positioning and velocity data can be updated in real time on a continuous basis by an unlimited number of users.

Although GPS enabled devices are often used to describe navigational devices, it will be appreciated that satellites need not be used to determine a geographic position of a receiving unit since any receiving device capable of receiving the location from at least three transmitting locations can perform basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit. In this way, personal hand held devices, cell phones, intelligent appliances, intelligent apparel, and others can be readily located geographically, if appropriated equipped to be a receiving unit.

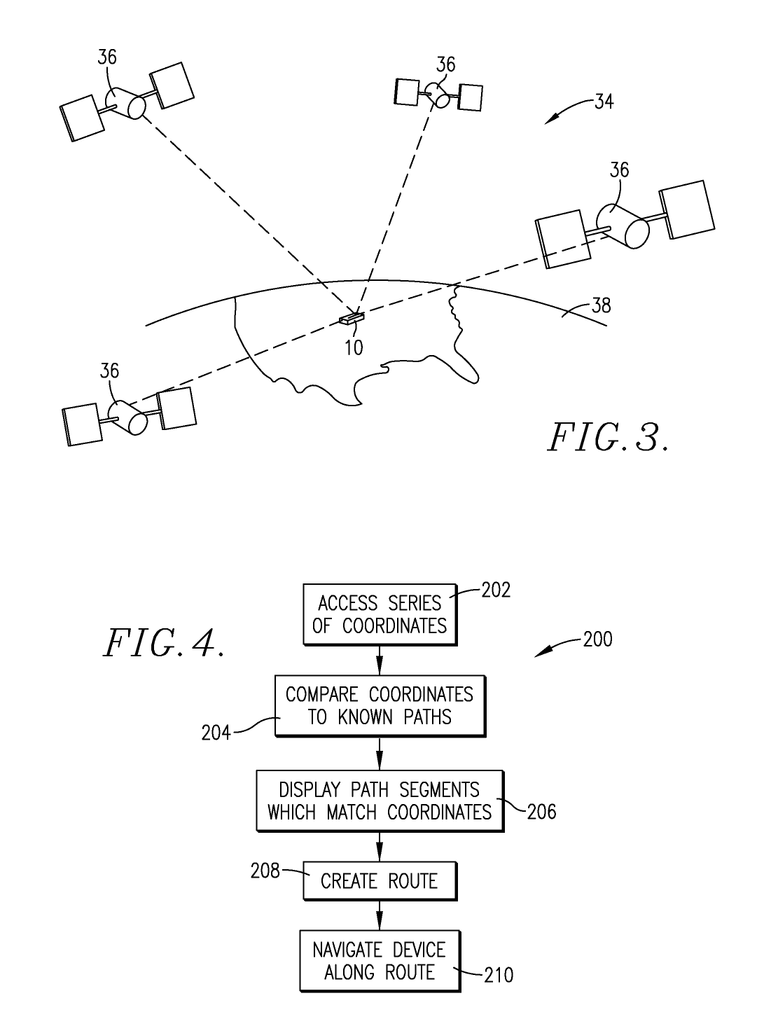

FIG. 3 shows one representative view of a GPS denoted generally by reference numeral 34. A plurality of satellites 36 are in orbit about the Earth 38. The orbit of each satellite is not necessarily synchronous with the orbits of other satellites and, in fact, is likely asynchronous. A GPS receiver device 10 such as the ones described in connection with preferred embodiments of the present invention is shown receiving spread spectrum GPS satellite signals from the various satellites 30.

The spread spectrum signals continuously transmitted from each satellite 36 utilize a highly accurate frequency standard accomplished with an extremely accurate atomic clock. Each satellite 36, as part of its data signal transmission, transmits a data stream indicative of that particular satellite. The device 10 must acquire spread spectrum GPS satellite signals from at least three satellites for the GPS receiver device to calculate its two-dimensional position by triangulation. Acquisition of an additional signal, resulting in signals from a total of four satellites, permits the device 10 to calculate its three-dimensional position.

The location determining component 12 and processing system 16 are operable to receive navigational signals from the GPS satellites 36 and to calculate positions of the device 10 as a function of the signals. The location determining component 12 and processing system 16 may, for example, determine a track log or any other series of geographic coordinates corresponding to points along a path traveled by a user of the device. The location determining component 12 and/or the processing system 16 are also operable to calculate a route to a desired location, provide instructions to navigate to the desired location, display maps and other information on the display screen 14, and to execute other functions described herein.

The location determining component 12 may include one or more processors, controllers, or other processing systems and memory so that it may calculate location and other geographic information without the processing system 16 or it may utilize the components of the processing system 16. Further, the location determining component 12 may be integral with the processing system 16 such that the location determining component 12 may be operable to specifically perform the various functions described herein. Thus, the processing system 16 and location determining component 12 can be combined or be separate or otherwise discrete elements.

In other embodiments, the location determining component 12 need not directly determine the current geographic location of the device 10. For instance, the location determining component 12 may determine the current geographic location by receiving location information directly from the user, through a communications network, or from another electronic device.

The location determining component 12 may include an antenna to assist in receiving the satellite signals. The antenna may be a quad-helix antenna or any other type of antenna that can be used with navigational devices. The antenna may be mounted directly on or in the housing 32 or may be mounted external to the housing.

The display 22 is coupled with the processing system and is operable to display various information corresponding to the device 10, such as price information, maps, locations, and directions as is described below. The display may comprise color display elements (or alternatively, black and white or monochrome display elements) including, but not limited to, LCD (Liquid Crystal Diode), TFT (Thin Film Transistor) LCD, CRT (Cathode Ray Tube), LEP (Light Emitting Polymer or PLED (Polymer Light Emitting Diode), and/or plasma display devices. Preferably, the display is of sufficient size to enable the user to easily view the display to receive presented information while in transit.

Further, as described above, the display 14 may be integrated with the user interface 20, such as in embodiments where the display 14 is a touch-screen display to enable the user to interact with the display 14 by touching or pointing at display areas to provide information to the device 10.

The processing system 16 may include any number of processors, controllers, integrated circuits, programmable logic devices, or other processing systems and resident or external memory for storing data and other information accessed and/or generated by the device 10. The processing system 16 is coupled with the location determining component 12, memory 18, user interface 20, and display 14, through wired or wireless connections, such as a data bus 40, to enable information to be exchanged between the various components.

The processing system 16 implements a computer program which converts GPS track logs and other series of geographical coordinates to routes matched to a road network or other known path from a database of known paths. In exemplary embodiments, the computer program comprises an ordered listing of executable instructions for implementing logical functions in the processing system. The computer program can be embodied in any computer-readable medium for use by or in connection with an instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The memory 18 may be integral with the location determining component 12, integral with the processing system 16, stand-alone memory, or a combination of both. The memory may include, for example, removable and non-removable memory elements such as RAM, ROM, flash, magnetic, optical, USB memory devices, and/or other conventional memory elements.

The memory 18 may store various data associated with operation of the device 10, such as the computer program and code segments mentioned above, or other data for instructing the processing system 16 and other device elements to perform the steps described herein. Further, the memory 18 may store various cartographic data corresponding to geographic locations including map data, and map elements, such as thoroughfares, terrain, alert locations, points of interest, geographic entities, radio stations, and other navigation data to facilitate the various navigation functions provided by the device 10. Additionally, the memory 18 may store destination addresses and previously calculated or otherwise acquired routes to various destination addresses for later retrieval by the processing system 16.

In accordance with one important aspect of the present invention, the memory 18 or some other memory accessible by the processing system 16 stores a database of known paths including known roads, road networks, road segments, intersections, hiking trails, tracks, sidewalks or any other known paths for which the geographic coordinates are known. As used herein, “roads” is meant to include all navigable pathways including, but not limited to, highways, streets, boulevards, avenues, parkways, rural routes, terraces, and even private streets, driveways, and parking lots. The database of known paths may be pre-loaded in the memory 18 or other memory or may be downloaded to the device via the communications element 24, receiver 28, or I/O ports. For example, different databases of known paths may be downloaded to the device based on a current location of the device as determined by the location determining component 12 or processing system 16.

The various data stored within the memory 18 may be associated within one or more databases to facilitate retrieval of the information. For example, the databases may be configured to enable the processing system 16 to automatically access the database of known paths based upon a current geographic location of the device 10 as discussed in more detail below.

As described below, a search engine, which may be comprised of software, firmware or the like executed by the processing system 16, may search through the database of known paths to find known roads or other known paths which match a series of geographical coordinates. A user may initiate a search or the search engine may automatically search the database based on a state of the device 10 such as the current position of the device 10.

The search engine, or alternatively a separate computation engine (which may also be comprised of software, firmware or the like executed by the processing system 12), may also perform calculations related to the known paths from the database such as determining which known path best matches the series of geographic coordinates, which known path provides the fastest and/or shortest route between start and finish points in the series of geographic coordinates, or the like.

The user interface 20 permits a user to operate the device 10 and enables users, third parties, or other devices to share information with the device 10. The user interface 20 is generally associated with the housing 32, such as by physical connection through wires, etc, or wirelessly utilizing conventional wireless protocols. Thus, the user interface 20 need not be physically coupled with the housing 32.

The user interface 20 may comprise one or more functionable inputs such as buttons, switches, scroll wheels, a touch screen associated with the display, voice recognition elements such as a microphone, pointing devices such as mice, touchpads, trackballs, styluses, a camera such as a digital or film still or video camera, combinations thereof, or the like. Further, the user interface 20 may comprise wired or wireless data transfer elements such as removable memory including the memory 18, data transceivers, etc, to enable the user and other devices or parties to remotely interface with the device 10. The device 10 may also include a speaker for providing audible instructions and feedback.

The user interface 20 may be operable to provide various information to the user utilizing the display 14 or other visual or audio elements such as a speaker. Thus, the user interface 20 enables the user and device 10 to exchange information relating to the device 10, including fuel station information, geographic entities, configuration, security information, preferences, route information, points of interests, alerts and alert notification, navigation information, waypoints, a destination address, or the like.

The power source 22 is associated with the housing 32 to provide electrical power to various device 10 elements. For example, the power source 22 may be directly or indirectly coupled with the user interface 20, location determining component 12, processing system 16, memory 18, and/or display 14. The power source 22 may comprise conventional power supply elements, such as batteries, battery packs, or the like. The power source 22 may also comprise power conduits, connectors, and receptacles operable to receive batteries, battery connectors, or power cables. For example, the power source 22 may include both a battery to enable portable operation and a power input for receiving power from an external source such an automobile.

The communications element 24 enables the device 10 to communicate with other electronic devices or any other network enabled devices through a communication network, such as the Internet, a local area network, a wide area network, an ad hoc or peer to peer network, or a direct connection such as a USB, Firewire, or Bluetooth™ connection, or the like. Similarly, the device 10 may be configured to allow direct communication between similarly configured navigation devices, such that the device 10 need not necessarily utilize the communications network to share geographic location information.

In various embodiments the communications element 24 may enable the device 10 to wirelessly communicate with a communications network utilizing wireless data transfer methods such as WiFi (802.11), Wi-Max, Bluetooth™, ultra-wideband, infrared, cellular telephony, radio frequency, or the like. However, the communications element 34 may couple with a communications network utilizing wired connections, such as an Ethernet cable, and is not limited to wireless methods.

The transmitter 26 and receiver 28 or a transceiver assembly may be provided to enable wireless transmission of information. For example, in exemplary embodiments, the device 10 includes a Frequency Modulated (FM) receiver for receiving information such as music, Radio Data system (RDS) information, FM Traffic Message Channel (TMC) information, direct band information such as MSN Direct™ data, or the like. Alternatively, or in addition, the transmitter 26 and receiver 28 assemblies may comprise a short range transmitter and transmitter such as a Bluetooth™ receiver/transmitter assembly, a cellular telephone (e.g., TDMA (Time Division Multiple Access), CDMA (Code Division Multiple Access), GSM (Global System for Mobile Communication), etc.) receiver/transmitter assembly, or the like.

The I/O ports 30 permit data and other information to be transferred to and from the processing system 16 and the location determining component 12. As illustrated in FIG. 1, the I/O ports may include a TransFlash card slot 42 for receiving removable TransFlash cards and a USB port 44 for coupling with a USB cable connected to another processing system such as a personal computer. Navigational software, cartographic maps and other data and information may be loaded in the device 10 via the I/O ports, the receiver 28, or the communications element 24.

The housing 32 may be handheld or otherwise portable to facilitate easy transport of the device 10. In some embodiments, the housing 32 may be configured for mounting within or on an automobile or other vehicle in a generally conventional manner. The housing 32 may be constructed from a suitable lightweight and impact-resistant material such as, for example, plastic, nylon, aluminum, or any combination thereof. The housing 32 may include one or more appropriate gaskets or seals to make it substantially waterproof or resistant. The housing 24 may take any suitable shape for size, and the particular size, weight and configuration of the housing may be changed without departing from the scope of the present invention.

The components shown in FIG. 2 and described herein need not be physically connected to one another since wireless communication among the various depicted components is permissible and intended to fall within the scope of the present invention.

FIG. 4 illustrates certain steps in an exemplary method 200 for converting a track log to a navigational route matched to known route in accordance with an exemplary embodiment of the present invention. The particular order of the steps illustrated in FIG. 4 and described herein can be altered without departing from the scope of the invention. For example, some of the illustrated steps may be reversed, combined, or even removed entirely.

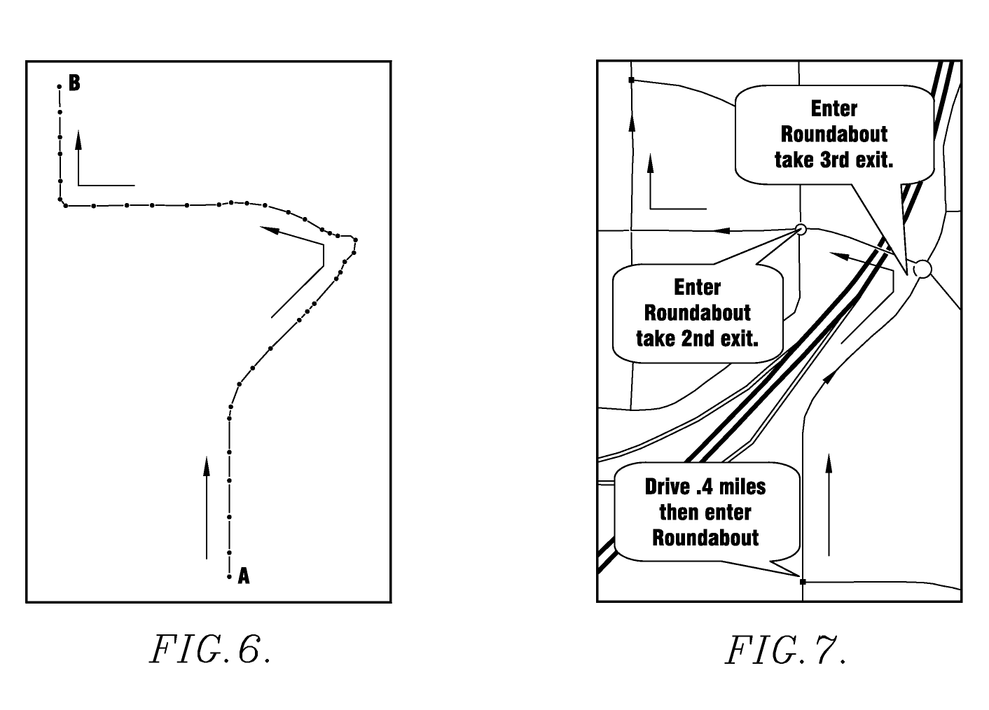

The processing system 16 or other component of the electronic device 10 first accesses a series of geographical coordinates as depicted in step 202. The series of geographical coordinates may be, for example, a track log corresponding to the coordinates of points along a path over which the user has traveled. An exemplary track log starting at point A and ending at point B is shown in FIG. 6. The processing system may access the series of geographical coordinates from the memory 18 or may obtain them directly from the location determining component 12.

The processing system 16 may access the series of geographical coordinates when directed to by a user of the device. For example, a user may click on a “route creation” window, tab, or button on the user interface 20 to request to have a track log converted to a navigational route matched to a known road. Alternatively, the processing system 16 may access the series of geographical coordinates automatically based on some status of the device such as a current location of the device.

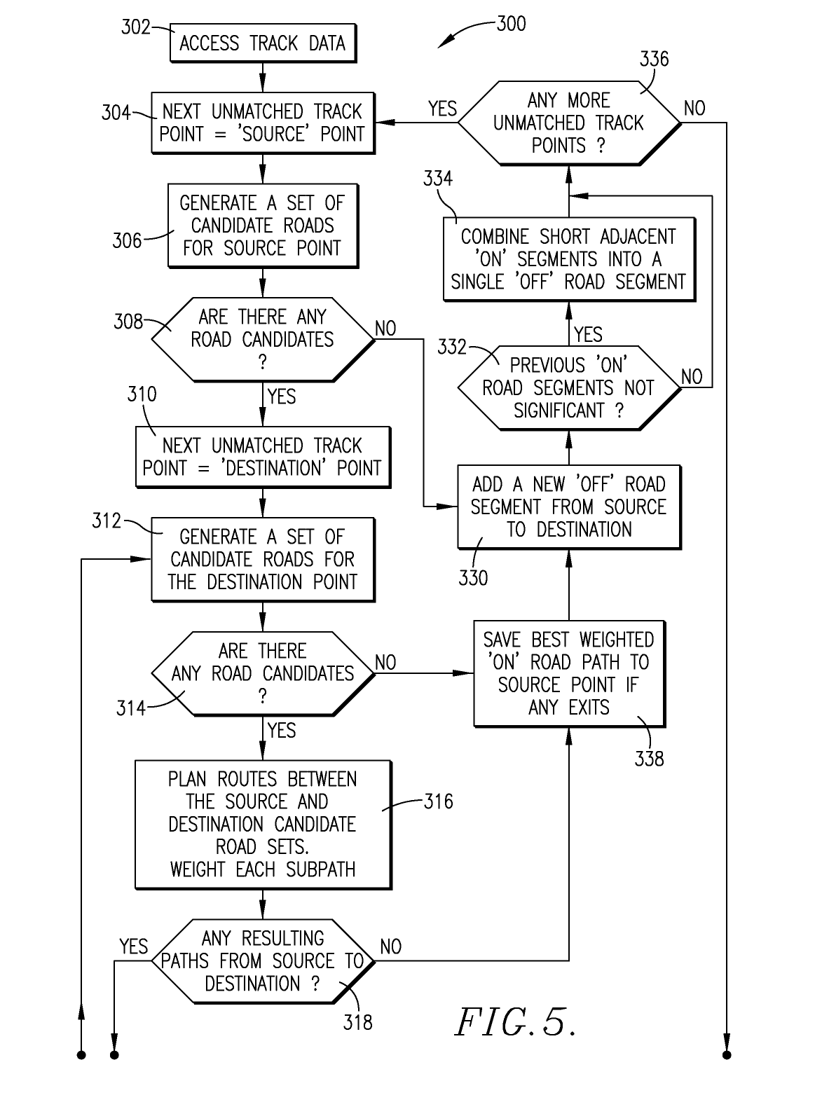

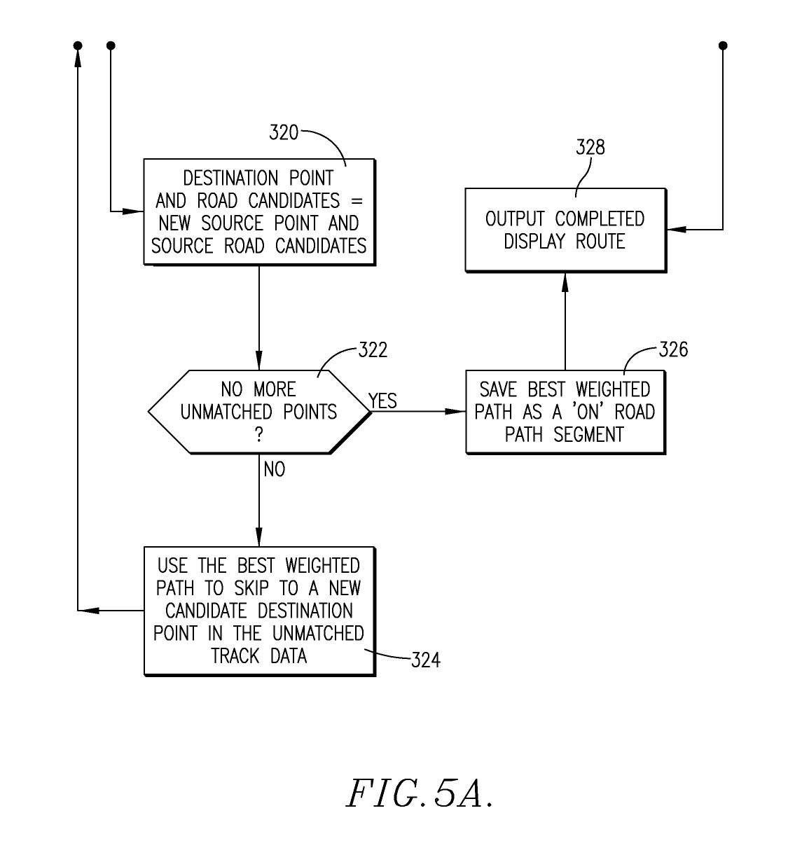

Once the series of geographical coordinates have been accessed, they are compared to the database of known paths in an attempt to find a known path, or combination of known paths, which matches the series of geographical coordinates as depicted in step 204. As explained in more detail below, with respect to FIG. 5, the processing system 16 attempts to match the series of geographical coordinates to a known road or road network when possible while preserving the position and shape of the geographical coordinates.

The known path or paths which match the series of geographical coordinates are then displayed on the display as shown in step 206. For example, a road or road network which matches the coordinates may be displayed on a map page of the device. The series of geographical coordinates may also be superimposed over the matching road network.

The processing system then creates and displays a route and/or other navigational information that assists the user in following the matching road or road network or other matched path or paths as depicted in step 208. Preferably, the resulting route generally preserves the position and shape of the original track log, but is matched to a road network where possible. FIG. 7 illustrates an exemplary display showing a route matched to the track log shown in FIG. 6 and navigational information shown along the route. The navigational information may include, for example, turn-by-turn instructions, heading arrows, or the like.

The device may then navigate the user along the displayed route as depicted in step 210. To do this, the processing system may continuously determine the current location of the device and then instruct the user when and where to turn in order to closely follow the route. For example, as shown in FIG. 7, the device may display the instructions “Drive 0.4 miles then enter Roundabout”, “Enter Roundabout, take 3^{rd} exit”, and “Enter Roundabout take 2^{nd} exit” when the location determining component determines that the device is at particular locations along the displayed route.

The processing system 16 may also cause at least a portion of the route and optionally the navigational information to be stored in memory 18 such as an internal memory or a removable memory (e.g., an SD card, or the like). The generated route and navigation information may be stored directly to memory when created or saved to memory after being displayed to the user (and/or navigated). Additionally, once determined, at least a portion of the route may be shared with other electronic devices. For example, the route, or portion thereof, may be stored on a removable memory and transferred from the electronic device 10 to one or more second electronic devices. Alternatively, the route, or portion thereof, may be transmitted between the electronic device 10 and a second electronic device via a wired or wireless connection (e.g., WiFi (802.11), Wi-Max, Bluetooth™, ultra-wideband, infrared, cellular telephony, radio frequency, or the like).

FIG. 5 and FIG. 5A illustrate certain steps in a more detailed exemplary method 300 of using the electronic device 10. As with the method 200 illustrated in FIG. 4, the particular order of the steps illustrated in FIG. 5 and FIG. 5A and described herein can be altered without departing from the scope of the invention.

In general, the method 300 uses a GPS track log to create a navigational route matched to a database of known road networks. The method calculates when the track log converges or diverges from roads in the road database. The resulting navigational route preserves the position and shape of the original track log, but is matched to a road network where possible. Groups of non-map matched points are added to the route as off-route segments. This conversion allows the device 10 to guide a user along a route matched to a track log while providing features such as turn-by-turn directions and the like. The method may be used, for example, when a user travels over a scenic set of roads, hiking trails, or any other path and saves a track log for the path. If the user wants to conveniently re-trace the path at a later date, the processing system accesses the track log, compares it to the database of known paths, and then displays the track log over the known path which most closely matches the track log. The processing system may also display navigational information such as turn-by-turn instructions and the like to assist the user in following the track log on the known path.

In the method 300, the processing system 16 or other component of the electronic device 10 first accesses a track log, track data, or any other series of geographical coordinates as depicted in step 302. The series of geographical coordinates may be, for example, a track log corresponding to the coordinates of points along a path over which the user has traveled. An exemplary track log starting at point A and ending at point B is shown in FIG. 6. The processing system may access the series of geographical coordinates from the memory or may obtain them directly from the location determining component. As with the method 200, the processing system may access the track log or other series of geographical coordinates when instructed to do so by a user of the device or automatically based on some status of the device such as a current location of the device.

The processing system then designates the next unmatched track point in the track log as the “source” point as depicted in step 304. When step 304 is performed for the first time, the next unmatched track point, and hence the source point, will be the first geographical coordinate in the track log.

The processing system 16 then searches the database of known paths to generate a set of candidate roads for the source point as depicted in step 306. This may be done, for example, by locating all roads or other paths in the database which encompass geographical coordinates within a specified distance of the geographical coordinates of the source point using conventional matching heuristics. The processing system attempts to match the source point to a known road or road network when possible while preserving the position and shape of the geographical coordinates. The candidate road segments are generated using map matching heuristics which use a combination of distance and heading matching to compare roads within a given distance from the track segment and weigh those further based on heading. The matching heuristics are changed based on whether the device is at an “off” to “on” road transition under the assumption that if it is “on” road it is more likely to stay on road.

In step 308, a determination is made whether any road candidates were found. If so, the method moves to step 310 where the processing system designates the next unmatched track point as being the “destination” point. In step 312, the database is then searched for known paths to generate a set of candidate roads for the destination point as depicted in step 312. The processing system attempts to match the destination point to a known road or road network when possible while preserving the position and shape of the geographical coordinates. As with the source point, the candidate road segments for the destination point are generated using map matching heuristics which use a combination of distance and heading matching to compare roads within a given distance from the track segment and weigh those further based on heading. The matching heuristics are changed based on whether the device is at an “off” to “on” road transition under the assumption that if it is “on” road it is more likely to stay on road.

In step 314, a determination is made whether any road candidates were found in step 312. If so, the method moves to step 316 where the processing system uses pathfinding algorithms to plan routes and generate maneuver guidance between the source and destination candidate road sets. Each set of candidate roads is weighted by how well it fits the track log. The pathfinding algorithm is similar to conventional routing algorithms except that it stays within a “corridor” from the current track segment to ensure the resulting routes do not deviate excessively from the shape of the track segment. This helps reduce on alternatives and also reduces the time required for path planning.

In step 318, a determination is made whether any acceptable paths were found from the source point road candidates to the destination point road candidates. If so, the method moves to step 320 where the processing system makes the destination point the new source point and the destination road candidates the source road candidates and then repeats the calculations of step 316. Thus, in steps 306, 312, and 316, a set of candidate roads for the source and destination point and a route between the candidate roads are calculated. After completing the match for a segment of the track log between two of the points, the destination point becomes the next source point. The new source point (old destination point) and associated candidate roads do not need to be recalculated because they are already known. The destination is simply used as the source and the remaining unmatched points are used as a new destination. Candidate roads are then calculated for the new destination.

In step 322, a determination is made whether there are no more unmatched points in the track log. If there are more unmatched points, the processing system uses the best weighted path, in step 324, and then returns to step 312 to generate a set of candidate roads for the next unmatched point in the track log.

If the processing system found no road candidates for the source point in step 308, the processing system adds a new “off road” segment from the source point to the destination point in step 330. In step 332, a determination is then made whether any previous “on road” segments were insignificant. If the previous on road segments were insignificant, the processing system combines the insignificant on road segments with the off road segment in step 334. A determination is them made in step 336, whether any more unmatched track points exist. If so, the method returns to step 304.

If no road candidates were found for the destination point in step 314, the processing system saves the best weighted on road path for the source point in step 338 and the proceeds to step 330. Similarly, if no paths were found from the source point to the destination point in step 318, the method moves to step 338.

If there are no more unmatched points in the track log in step 322, the best weighted path is saved as an “on road” path segment in step 326. The processing system then moves to step 328 to display the best weighted path along with related navigational information as shown in FIG. 7 and as explained above with respect to the method 200. Similarly, if there are no more unmatched points in the track log in step 336, the method moves to step 328.

At step 328, the processing system 16 may also cause at least a portion of the best weighted path and optionally the navigational information to be stored in memory 18 such as an internal memory or a removable memory (e.g., an SD card, or the like). The path and navigation information may be stored directly to memory when created or saved to memory after being displayed to the user. Additionally, once determined, at least a portion of the best weighted path may be shared with other electronic devices. For example, best weighted path, and associated navigational information, may be stored on a removable memory and transferred from the electronic device 10 to one or more second electronic devices or transmitted between the electronic device 10 and a second electronic device via a wired or wireless connection (e.g., WiFi (802.11), Wi-Max, Bluetooth™, ultra-wideband, infrared, cellular telephony, radio frequency, or the like).

Although the invention has been described with reference to exemplary embodiments illustrated in the attached drawing figures, it is noted that equivalents may be employed and substitutions made herein without departing from the scope of the invention as recited in the claims. For example, although the present invention is especially well-suited for converting track logs to routes matched to known road networks, it may also be used to convert any geographical coordinates to routes matched to any known paths. Further, the electronic device 10 and its components illustrated and described herein are merely examples of a device and components that may be used to implement the present invention and may be replaced with other devices and components without departing from the scope of the present invention.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. An electronic device, comprising:
a display for displaying information; and
a processing system coupled to the display for accessing a series of geographic coordinates and matching the series of geographic coordinates to a known path,
wherein the processing system causes the display to display at least a portion of the known path.

2. The electronic device as claimed in claim 1, wherein the processing system further causes the display to display navigation information for assisting a user of the electronic device in generally following the series of geographic coordinates while traveling on the portion of the known path.

3. The electronic device as claimed in claim 2, wherein the navigational information is selected from the group consisting of a route, turn-by-turn instructions, detour routing, and heading information.

4. The electronic device as claimed in claim 1, wherein the known path is selected from the group consisting of a known road, a known road network, a known trail, a known trail network, a known hiking path, a known hiking path network, a known track, and a known track network.

5. The electronic device as claimed in claim 4, wherein the series of geographic coordinates comprise all or at least a part of a track log.

6. The electronic device as claimed in claim 1, further including a location determining component for determining the series of geographic coordinates while a user of the device travels to points corresponding to the geographic coordinates.

7. The electronic device as claimed in claim 6, wherein the location determining component is a GPS receiver operable for receiving satellite signals from a plurality of GPS satellites and for determining the geographic coordinates as a function of the satellite signals.

8. The electronic device as claimed in claim 1, further including a user interface coupled with the processing system for permitting a user to instruct the processing system to match the series of geographic coordinates to the known path.

9. The electronic device as claimed in claim 1, further including memory for storing the series of geographic coordinates and data for the known path.

10. The electronic device as claimed in claim 1, further including a communications apparatus for at least one of receiving information from and transmitting information to an external source, the communication device for sharing at least a portion of the known path with the external source.

11. The electronic device as claimed in claim 10, wherein the communications apparatus comprises a radio frequency transceiver.

12. The electronic device as claimed in claim 1, wherein the series of geographic coordinates is received from an external source.

13. An electronic device, comprising:
a display for displaying information;
a location determining component for determining a series of geographic coordinates corresponding to points along a path traveled by a user of the device;
a processing system coupled with the display and the location determining component for accessing the series of geographic coordinates, comparing the series of geographic coordinates to geographic coordinates of known paths, and selecting a known path which most closely matches the series of geographic coordinates,
wherein the processing system causes the display to display at least a portion of the known path which most closely matches the series of geographic coordinates.

14. The electronic device as claimed in claim 13, wherein the processing system further causes the display to display navigational information for assisting a user of the device in generally following the series of geographic coordinates while traveling on the portion of the known path.

15. The electronic device as claimed in claim 13, wherein the known path is selected from the group consisting of a known road, a known road network, a known trail, a known trail network, a known hiking path, a known hiking path network, a known track, and a known track network.

16. The electronic device as claimed in claim 13, wherein the series of geographic coordinates are a part of a track log.

17. The electronic device as claimed in claim 13, wherein the navigational information is selected from the group consisting of a route, turn-by-turn instructions, detour routing, and heading information.

18. The electronic device as claimed in claim 13, wherein the location determining component is a GPS receiver operable for receiving satellite signals from a plurality of GPS satellites and for determining the geographic coordinates as a function of the satellite signals.

19. The electronic device as claimed in claim 18, further including a user interface coupled with the processing system which permits a user to instruct the processing system to compare the series of geographic coordinates to the known path.

20. The electronic device as claimed in claim 13, further including memory for storing the series of geographic coordinates and data for the known paths.

21. The electronic device as claimed in claim 13, further including a communications apparatus for at least one of receiving information from and transmitting information to an external source, the communication device for sharing at least a portion of the known path with the external source.

22. The electronic device as claimed in claim 21, wherein the communications apparatus is selected from the group consisting of a radio transceiver; a Bluetooth™ transceiver; and a cellular transceiver.

23. The electronic device as claimed in claim 13, wherein the series of geographic coordinates is received from an external source.

24. A method of displaying a route on a display of a navigational device, the method comprising the steps:
accessing a series of geographical coordinates;
comparing the series of geographical coordinates to a plurality of known paths;
determining which of the plurality of known paths best matches the series of geographical coordinates; and
displaying at least a portion of the known path which best matches the series of geographical coordinates.
